(19) United States
(12) Patent Application Publication
(10) Pub. No.: US 2004/0081842 A1
(43) Pub. Date: Apr. 29, 2004

(54) FILM WITH METALLOCENE-CATALYZED PROPYLENE COPOLYMER HEAT-SEAL LAYER

(76) Inventor: Robert G. Peet, Pittsford, NY (US)

Correspondence Address: EXXONMOBIL CHEMICAL COMPANY, P O BOX 2149, BAYTOWN, TX, 77522-2149, US

(21) Appl. No.: 10/282,981

(22) Filed: Oct. 29, 2002

(51) Int. Cl. B32B 27/00

(52) U.S. Cl. 428/515; 428/422.8

(57) ABSTRACT

A multilayer film structure including a base layer containing a film-forming thermoplastic polymer and a heat-seal layer containing a metallocene-catalyzed propylene copolymer, wherein the copolymer contains from 80 to 99.5 wt % of propylene and from 0.5 to 20 wt % of an α-olefin, based on the entire weight of the copolymer. Multilayer film structures according to the present invention exhibit excellent hot tack characteristics. In addition, film structures according to the invention allow for higher production rates of packages on both vertical and horizontal form-and-fill sealing equipment because the film need not be heated to as great a temperature to make a strong seal.

### BACKGROUND OF THE INVENTION

The invention relates to a film structure exhibiting improved “hot tack.” In particular, the invention relates to a film structure comprising a metallocene-catalyzed copolymer heat-seal layer, and to a method of manufacturing the film structure.

In most processes for packaging products, including foodstuffs, such as potato chips, nuts, candy, biscuits, and spices, and hardware, such as nuts, bolts, screws, and nails, the package is formed and filled by (i) creating a seal between two opposing film webs, each having at least one skin layer capable of forming a seal under the application of heat and pressure, to form a pocket, and (ii) almost simultaneously sliding or dropping the product into the pocket.

For example, a continuous flat web of packaging film may be fed around a hollow form which shapes the film into a tube. The free edges of the tube are sealed together. A tube thus formed is then passed between a pair of hot sealing jaws positioned across, or transverse, to the tube. The jaws create a series of discrete packages by collapsing the film onto itself and forming a seal through the application of heat and pressure to sealing layers in the film structure. The product is introduced into each package through the hollow form in the interval between the heat seals. In the overall process, packages made in the foregoing manner are subsequently cut, separated, and collected into appropriate assemblies.

At high operating speeds, the product is dropped into the package while the sealing jaws, which form the seal, are closed. Alternatively, the product may be dropped into the package at the point that the sealing jaws are opening. With both vertical and horizontal form-and-fill sealing applications, the heat-seal should be strong enough to support and retain the product after the sealing jaws re-open to release the film. In order to achieve maximum operating speeds, the sealing jaws must be released as quickly as possible after the seal is formed.

“Hot tack” is defined as the strength of a hot seal measured after completion of the sealing cycle, but prior to the temperature of the seal cooling to any substantial extent, i.e., the measure of the cohesive strength during the cooling stage before solidification of the heat seal. Hot tack is measured in force per unit of seal width, e.g., g/in. Hot tack is important in form-fill-seal packaging applications, where the critical window of time is when the seal is in the packaging machine and must resist the stresses of the product bearing onto the heat seal. This critical window of time starts the instant the sealing jaws of the machine open, and continues until the sealed package is delivered from the machine to a conveyor belt or any other device used to assemble product. It may be about a second in duration (more or less), depending on the machine speed and the particular product being packaged. During this period, the seal is cooling and its strength is increasing. A seal that opens ⅛″ or less for a given stress load at a given temperature is considered to have satisfactory hot tack at that temperature and stress.

In general, a packaging film should be capable of handling heavy loads of product at very high speeds. At high speed, heat transfer to the sealing layer(s) from the heat-sealing jaws will limit the actual sealing temperature/sealant layer temperature. For the best packaging performance, an ideal film structure exhibits the highest-possible hot tack strength at a temperature that falls as close as possible to the minimum sealing temperature (MST) of the film structure. This would result in the fastest line operating speed that can be achieved. Additionally, a sealant layer that has a strong hot tack over a broad temperature range allows the film to be used in applications in which the packaging may vary substantially in operating speed and resultant sealing temperature range.

U.S. Pat. No. 5,462,807 to Halle, et al. is directed to heat-sealable film structures comprising an ionomer layer and a heat-sealable layer. Although the '807 patent broadly discloses a heat-sealable layer comprising a metallocene-catalyzed homopolymer or copolymer, the '807 patent is specifically directed to so-called metallocene-catalyzed ethylene copolymers containing from 70-99.99 wt % of ethylene. There is no specific disclosure within the '807 patent of a metallocene-catalyzed propylene copolymer. It is completely unexpected from the '807 patent that metallocene-catalyzed propylene copolymers achieve high hot tack strength.

U.S. Pat. No. 5,468,440 to McAlpin, et al. discloses film structures comprising a layer of a metallocene-catalyzed propylene homopolymer or copolymer. Although the '440 patent discloses metallocene-catalyzed propylene copolymers, the specific metallocene-catalyzed propylene copolymer of the present invention is not disclosed. Specific use and benefits as a sealant layer are not taught or mentioned in the '440 patent. It does not suggest that a film structure comprising a heat-seal skin layer comprising the present metallocene-catalyzed propylene copolymer would exhibit superior hot tack characteristics.

U.S. Pat. No. 5,529,843 to Dries, et al. relates to a composite film having a sealable top layer comprising an isotactic olefinic homopolymer. According to the '843 patent, the isotactic olefinic homopolymer is metallocene-catalyzed, and covers both homopolymers and polymers predominantly composed of one monomer along with a small fraction of other comonomers, wherein the fraction is so small that the essential properties of the homopolymer are not affected. The specific metallocene-catalyzed propylene copolymer of the present invention is not disclosed, nor would it be expected from the '843 patent that a film structure comprising a heat-seal skin layer comprising the present metallocene-catalyzed propylene copolymer would exhibit superior hot tack characteristics.

U.S. Pat. No. 6,242,084 to Peet relates to an opaque, biaxially oriented film which contains at least one layer of metallocene-catalyzed substantially isotactic propylene polymer. The specific metallocene-catalyzed propylene copolymer of the present invention is not disclosed, nor would it be expected from the '084 patent that a film structure comprising a heat-seal skin layer comprising the present metallocene-catalyzed propylene copolymer would exhibit superior hot tack characteristics.

In short, there exists a need in the art for film structures having improved hot tack.

### SUMMARY OF THE INVENTION

A multilayer film structure comprising:

(a) a base layer comprising a film-forming polyolefin; and

(b) a heat-seal layer comprising a metallocene-catalyzed propylene copolymer,

wherein the copolymer comprises from 80 to 99.5 wt % of propylene and from 0.5 to 20 wt % of an α-olefin, based on the entire weight of the copolymer.

A multilayer film structure according to the present invention exhibits excellent hot tack characteristics. In addition, film structures according to the invention allow for higher production rates of packages on both vertical and horizontal form-and-fill sealing equipment because the film need not be heated to as great a temperature to make the seal.

### BRIEF DESCRIPTION OF THE DRAWING

FIG. 1 is a line graph comparing the hot tack strength as a function of temperature of a film structure according to the present invention comprising a metallocene-catalyzed copolymer heat-seal layer with a pair of prior art film structures, each comprising a Ziegler-Natta-catalyzed terpolymer heat-seal layer.

### DETAILED DESCRIPTION OF THE INVENTION

The base layer of the film structure comprises a polymeric matrix comprising any of the film-forming thermoplastic polymers. A polyolefin having a melting point, for example, of at least about 150° C. and up to, for example, about 167° C., represents one example of a suitable film-forming polymer for forming the polymeric matrix of the base layer. If the film-forming polymer of the base layer is a polyolefin, the polyolefin preferably has a relatively high degree of crystallinity. A particularly desirable polyolefin that may be used as the film-forming polymer is an isotactic propylene homopolymer having (i) an isotacticity of from about 80 to 99%, (ii) a melting point of from about 155° C. to about 165° C., and (iii) a melt flow of from about 0.5 to about 15 g/10 minutes (as measured according to ASTM D1238). The isotactic propylene polymer may be produced by using Ziegler-Natta or metallocene catalysts. Metallocene-catalyzed isotactic polypropylenes made developmentally or commercially include, but are not limited to, EOD 96-21 and EOD 97-09, from Atofina Petrochemicals, Inc., and EXPP-129, from ExxonMobil Chemical Co.

It will be understood by one of ordinary skill in the art that an isotactic propylene homopolymer that has an isotacticity of from about 80 to 99% includes so-called standard, film-grade isotactic polypropylene and highly crystalline polypropylene. Standard, film-grade isotactic polypropylene has an isotactic stereoregularity of from about 89% to about 93%. Highly crystalline polypropylene (HCPP) has an isotactic stereoregularity greater than about 93%. HCPP exhibits higher stiffness, surface hardness, lower deflection at higher temperatures and better creep properties than standard, film-grade isotactic polypropylene. Further information relating to HCPP, including methods for preparation thereof, is disclosed in U.S. Pat. No. 5,063,264, incorporated herein by reference. Commercially available HCPPs include Amoco 9117 and Amoco 9119 (available from Amoco Chemical Co. of Chicago, Ill.), and Chisso HF5010 and Chisso XF2805 (available from Chisso Chemical Co., Ltd. of Tokyo, Japan). Suitable HCPPs are also available commercially from Solvay in Europe.

For purposes of the present invention, stereoregularity can be determined by IR spectroscopy according to the procedure set out in “Integrated Infrared Band Intensity Measurement of Stereoregularity in Polypropylene,” J. L. Koenig and A. Van Roggen, Journal of Applied Polymer Science, Vol. 9, pp. 359-367 (1965) and in “Chemical Microstructure of Polymer Chains,” Jack L. Koenig, Wiley-Inerscience Publication, John Wiley and Sons, New York, Chichester, Brisbane, Toronto. Alternatively, stereoregularity can be determined by decahydronaphthalene (decalin) solubility or nuclear magnetic resonance spectroscopy (NMR), e.g., ¹³C NMR spectroscopy using meso pentads.

Other suitable film-forming polymers that may be used to form the polymeric matrix of the base layer include, but are not limited to, syndiotactic polypropylene, ethylene-propylene copolymers, ethylene-propylene-butene-1 terpolymers, butylene-ethylene copolymers, functionally grafted copolymers, blends of polymers, etc.

Although it is preferred for the base layer to comprise a polymeric matrix comprising any of the propylene homopolymers, copolymers, or terpolymers described above, in an alternative embodiment, the polymeric matrix of the base layer comprises an ethylene resin, such as a high density polyethylene (HDPE), medium density polyethylene (MDPE), low density polyethylene (LDPE), very low density polyethylene (VLDPE), or linear low density polyethylene (LLDPE).

HDPE is a substantially linear polyolefin having a density of, for example, from about 0.95 g/cm³ or higher, e.g., from about 0.952 g/cm³ to about 0.970 g/cm³, and a melting point of, for example, from about 266° F. to about 299° F. (from about 130° C. to about 148° C.).

MDPE has a density in the range of from about 0.926 g/cm³ to about 0.940 g/cm³.

LDPE typically has a density in the range of from 0.90 g/cm³ to 0.94 g/cm³, e.g., from 0.910 g/cm³ to 0.926 g/cm³, and a melt index of from less than 1 to 10 g/10 min (as measured according to ASTM D1238). LDPE may be derived solely from ethylene, e.g., in a high pressure, peroxide-catalyzed reaction, or from ethylene together with a comonomer, including but not limited to higher olefin comonomers containing 4 to 10 carbon atoms, e.g., butene-1, hexene-1, or octene-1, e.g., in a gas phase linear low density polyethylene (LLDPE) process or in a solution LLDPE process using Ziegler-Natta, metallocene, or single-site catalysts.

LLDPE typically has: a melt index of from less than 0.2 to 10 g/10 min (as measured according to ASTM D1238) and a density in the range of from 0.88 to 0.94 g/cm³, preferably from 0.89 to 0.92 g/cm³. It may be derived from ethylene together with other higher comonomers, such as butene-1, hexene-1 or octene-1.

VLDPE, which is sometimes referred to as ultra low density polyethylene (ULDPE), is a very low density polyethylene typically having a density at or below 0.915 g/cm³, e.g., from about 0.86 to about 0.915 g/cm³. VLDPE is typically produced in a high pressure, peroxide-catalyzed reaction or in a solution process. When produced using a metallocene or single-site catalyst, VLDPE is commonly referred to as a type of plastomer.

If it is desired to produce an opaque film structure, a cavitating agent(s) can be dispersed within the polymeric matrix of the base layer before extrusion and orientation. A suitable cavitating agent(s) includes any organic or inorganic material that is incompatible with (the term “incompatible” is used in the sense that the materials are two distinct phases), and has a higher melting point than, the film-forming polymer of the base layer, at least at the orientation temperature. For example, the cavitating agent(s) may be any of those described in U.S. Pat. Nos. 4,377,616 and 4,632,869, the entire disclosures of which are incorporated herein by reference. Specific examples of the cavitating agent(s) include polybutylene terephthalate (PBT), nylon, an acrylic resin, an ethylene-norborene copolymer, solid or hollow preformed glass spheres, metal beads or spheres, ceramic spheres, calcium carbonate, and combinations thereof. When the base layer comprising a cavitating agent(s) is subjected to uniaxial or biaxial orientation, a cavity forms, providing a film having an opaque appearance.

The particle size of the cavitating agent(s) may be, for example, from about 0.1 micron to about 10 microns, more preferably from about 0.2 micron to about 2 microns. The cavitating agent(s) may be of any desired shape. For example, the cavitating agent(s) may be substantially spherical. The cavitating agent(s) may be present in the base layer in an amount of less than 30 wt %, for example from 2 wt % to 20 wt %, e.g., from 5 wt % to 10 wt %, based on the total weight of the base layer.

The cavitating agent(s) may be dispersed within the polymeric matrix of the base layer by blending the cavitating agent(s) and the film-forming polymer that provides the polymeric matrix at a temperature above the melting point of the film-forming polymer. This blending may take place in an extruder, such as a co-rotating, intermeshing twin screw extruder.

To preserve the structural integrity of the base layer, a thin layer of the film-forming polymer of the base layer, without the cavitating agent(s), may be coextruded on one or both sides of the film-forming polymer of the base layer. In this case, the total of the cavitating agent(s)-containing layer and the non-cavitating agent(s)-containing layer(s) may be considered the overall base layer of the film.

The base layer may also comprise an opacifying agent(s). Examples of the opacifying agent(s) include iron oxide, carbon black, titanium dioxide, talc, and combinations thereof. The opacifying agent(s) may be present in the base layer in an amount of from 1 to 15 wt %, for example from 1 to 8 wt %, e.g., from about 2 to about 4 wt %, based on the total weight of the base layer. Aluminum is another example of an opacifying agent that may be used in the base layer of the present film structure. Aluminum may be included in the base layer as an opacifying agent in an amount of from 0.01 to 1.0 wt %, e.g., from about 0.25 to about 0.85 wt %, based on the total weight of the base layer.

The base layer may further comprise one or more hydrocarbon resins. The hydrocarbon resin(s) may be present in the base layer in a total amount of from 1 wt % to 15 wt %, for example from 1 wt % to 12 wt %, e.g., from 2 wt % to 6 wt %, based upon the total weight of the base layer.

The hydrocarbon resin(s) may be a low molecular weight hydrocarbon which is compatible with the film-forming polymer of the base layer. The hydrocarbon resin(s) may, optionally, be hydrogenated. The hydrocarbon resin(s) may have a number average molecular weight of less than 5,000, for example less than 2,000, e.g. from 500 to 1,000. The resin(s) may be natural or synthetic and may have a softening point in the range of from 60° C. to 180° C. A specific example of a hydrocarbon resin that may be contained in the present base layer is any of the hydrocarbon resins disclosed in U.S. Pat. No. 5,667,902 to Brew, et al., which is incorporated herein by reference. Specific examples include, but are not limited to, petroleum resins, terpene resins, styrene resins, and cyclopentadiene resins. Examples of commercially available hydrogenated resins include PICCOLYTE, REGALREZ, and REGALITE, each of which is available from Hercules Corp., and ESCOREZ, available from ExxonMobil Chemical Co.

A saturated alicyclic resin is an additional example of a hydrocarbon resin that may be included in the base layer of the present film structure. Saturated alicyclic resins have a softening point in the range of from 85° C. to 140° C., for example from 100° to 140° C., as measured by the ring and ball technique. An example of a commercially available saturated alicyclic resin is ARKON-P, available from Arakawa Forest Chemical Industries, Ltd. Of Japan.

The base layer of the film is of sufficient thickness to provide bulk properties, such as barrier, stiffness, etc. that are desired for product protection and good performance on packaging equipment. In preferred embodiments, the thickness of the base layer ranges from about 50% to about 99% of the entire thickness of the film structure.

The film structure comprises at least one heat-seal layer comprising a metallocene-catalyzed propylene copolymer. The film structure may further comprise at least one heat seal formed by contacting a surface of the at least one heat seal layer with another film surface under sufficient conditions of heat and pressure to form a seal. It will be readily understood by one of ordinary skill in the art that the “another film surface” may be a film surface from the same film structure, or a film surface from a separate film structure.

As used herein, the term “propylene copolymer” refers to polymers formed by the polymerization reaction of propylene with one or more different comonomers. As used herein, the term “metallocene-catalyzed” refers to polymers produced from single-site, or cyclopentadienyl-derivative, transition metal catalysts. These catalysts are well-known in the art.

In preferred embodiments, the metallocene-catalyzed propylene copolymer is formed by the polymerization reaction of propylene with an α-olefin comonomer. For example, the metallocene-catalyzed propylene copolymer may comprise from 80-99.5 wt % of propylene and from 0.5-20 wt % of an α-olefin, wherein the particular wt % is based on the weight of the copolymer as a whole. In particularly preferred embodiments, the metallocene-catalyzed propylene copolymer comprises from 89-98 wt % of propylene and from 2-11 wt % of an α-olefin, wherein the particular wt % is based on the weight of the copolymer as a whole. Although the α-olefin comonomer may be a C₂-C₈ olefin, for the most preferred embodiments, the α-olefin comonomer is ethylene.

Although the heat-seal layer may comprise a blend of the present metallocene-catalyzed propylene copolymer and other heat-seal materials, in certain embodiments, the heat-seal layer “essentially comprises” a metallocene-catalyzed propylene copolymer. As used herein, if a heat-seal layer “essentially comprises” a metallocene-catalyzed propylene copolymer, the heat-seal layer includes only one film-forming polymer, and the one film-forming polymer is a metallocene-catalyzed propylene copolymer. Although a heat-seal layer “essentially comprising” a metallocene-catalyzed propylene copolymer has only one film-forming polymer, other components, i.e., non-film-forming polymers, are not excluded from the heat-seal layer, including, for example, one or more of anti-blocks, anti-static agents, coefficient of friction (COF) modifiers, processing aids, colorants, clarifiers, etc.

The present metallocene-catalyzed propylene copolymer that has a high α-olefin comonomer content of from about 0.5 to 20 wt %, e.g., from about 2 to about 11 wt %, has a MST of below 225° F. (107° C.), for example from about 180° F. to about 210° F. (82° C. to 99° C.), preferably from about 185° F. to about 200° F. (85° C. to 93° C.), e.g., from about 190° F. to about 195° F. (88° C. to 90.5° C.).

Typically in the art of coextruded, heat-sealable films, a copolymer composition, such as, e.g., a Ziegler-Natta-catalyzed propylene copolymer with ethylene comonomer, wherein the copolymer has a MST below about 225° F. (107° C.) is not employed in a heat-seal layer. These types of copolymers tend to be very tacky, cause great problems in polymerization reactors, do not run well over heated rolls in the machine direction (MD) orientation section of the oriented polypropylene (OPP) process, and typically have extractables levels that exceed FDA criteria, among other problems. Accordingly, the use of a heat-seal layer comprising a copolymer composition having an MST of around 225° F. (107° C.), or more, represents the industry standard.

If a heat-seal layer must comprise a film-forming polymer that has a MST below about 225° F. (107° C.), the current practice has been to employ a Ziegler-Natta-catalyzed terpolymer of propylene with comonomers of ethylene and butylene as the film-forming polymer of the heat-seal layer. These types of terpolymers are less sticky, do not give as much problem within the reactors, can be run through the MD orientation section of the OPP process, and do not have as much problem meeting the FDA extractables regulations. Typically, however, they have poor to no hot tack. Many are completely unsatisfactory for vertical form-fill-seal use.

The present inventor has found that a film structure comprising, as a heat-seal layer, a metallocene-catalyzed propylene copolymer that has a high α-olefin comonomer content of from about 0.5 to 20 wt %, e.g., from about 2 to about 11 wt %, does not suffer from the aforementioned problems associated with other copolymer compositions, even though the present metallocene-catalyzed propylene copolymer has a MST of below 225° F. (107° C.).

More importantly, the present inventor has surprisingly found that a film structure comprising, as a heat-seal layer, a metallocene-catalyzed propylene copolymer having a high α-olefin comonomer content of from about 0.5 to 20 wt %, e.g., from about 2 to about 11 wt %, exhibits excellent hot tack characteristics. Consequently, the present film structures provide for higher production rates of packages on both vertical and horizontal form-and-fill sealing equipment because the film need not be heated to as great a temperature to make the seal.

The hot tack of a film structure may be evaluated by placing a film specimen over a flat spring and bending the specimen and spring into a “U” shape with the sealing surfaces placed together. The sealing surfaces are placed into the jaws of a crimp sealer to make a seal. While the sealing jaws are closed, the spring tension is released. The amount of tension (g/in) needed to pull the seals more than ⅛″ apart is the hot tack value.

For example, a particular film structure according to the present invention may exhibit a hot tack of: greater than 150 g/in over a temperature range of from about 198° F. to about 230° F. (from about 92° C. to about 110° C.); greater than 200 g/in over a temperature range of from about 202° F. to about 227° C. (from about 94° C. to about 108° C.); greater than 250 g/in over a temperature range of from about 205° F. to about 225° F. (from about 96° C. to about 107° C.); greater than 300 g/in over a temperature range of from about 208° F. to about 220° F. (from about 97.5° C. to about 104.5° C.); and a peak hot tack of about 335 g/in at a temperature of about 212° F. (about 100° C.). Thus, film structures according to the present invention not only achieve adequate (150 g/in) hot tack values over a broad temperature range, they also achieve a high peak hot tack (˜315 g/in) at a temperature close to its MST.

The film structure may be prepared so that a heat-seal layer is provided directly on one side of the base layer, or the film structure may be prepared so that one or more intermediate, or tie, layers are between the base layer and heat-seal layer. The film structure may be prepared, moreover, with one or more additional layers on the side of the base layer opposite the side of the heat-seal layer.

For example, the film structure may be represented, in simplified form, as having a structure “AC”, “ACE”, “ABCE”, “ACDE”, or “ABCDE”, wherein “C” represents a base layer, “B” and “D” represent intermediate layers adjacent to the base layer, “A” represents a heat-seal layer according to the present invention, which is either adjacent to the base layer “C” or adjacent to the outer surface of layer “B”, and “E” represents a skin layer, which is either adjacent to the base layer “C” or adjacent to the outer surface of layer “D”. Layers “A” and “B” may be the same or different, layers “D” and “E” may be the same or different, layers “B” and “D” may be the same or different, and layers “A” and “E” may be the same or different. Preferably, layers “A” and “C” are different. Additionally, structures containing more than five layers are contemplated, e.g., seven, nine, or more layers.

If present, the skin layer on the side of the base layer opposite the heat-seal layer is either adjacent to the base layer or separated from the base layer by one or more intermediate layers. The skin layer may comprise a polymeric matrix comprising any of the film-forming polymers. Suitable film-forming polymers that may be used to form the polymeric matrix of the skin layer include, but are not limited to, syndiotactic polypropylene, low density polyethylene (LDPE), linear low density polyethylene (LLDPE), medium density polyethylene (MDPE), high density polyethylene (HDPE), ethylene-vinyl acetate copolymers, ethylene-vinyl alcohol copolymers, nylons, polymers grafted with functional groups, blends of these, etc.

In one embodiment, the film-forming polymer of the skin layer is the same as the film-forming polymer of the heat-seal layer, i.e., the skin layer is also a metallocene-catalyzed propylene copolymer.

For certain embodiments, it may be desirable for the skin layer to be a Ziegler-Natta-catalyzed heat-seal layer. For example, it may be desirable for the film-forming polymer of the skin layer to comprise Ziegler-Natta-catalyzed polyolefinic copolymers, terpolymers, or blends thereof.

Suitable Ziegler-Natta-catalyzed copolymers include block or random copolymers of ethylene and propylene, butylene and propylene, and ethylene and butylene. A preferred copolymer is an ethylene-propylene (EP) random copolymer generally containing from about 2 to about 8 wt % ethylene, specifically from about 3 to about 7 wt % ethylene, the balance being made up of propylene. The copolymer may have a melt index at 230° C. generally ranging from about 2 to about 15 g/10 min, and preferably from about 3 to about 8 g/10 min. The crystalline melting point is usually from about 120° C. to about 150° C. and the number average molecular weight range is from about 25,000 to 100,000. The density will usually range from about 0.89 to about 0.92 g/cm³. An example of a commercially available copolymer that may be used as the skin layer is Z9470, available from Atofina Petrochemicals, Inc.

Suitable Ziegler-Natta-catalyzed terpolymers include ethylene-propylene-butene-1 terpolymers. A preferred terpolymer is an ethylene-propylene-butene-1 (EPB) terpolymer obtained from the random inter-polymerization of from about 1 to about 8 weight percent ethylene, preferably from about 3 to about 7 weight percent ethylene with from about 1 to about 15 weight percent butene-1, preferably from about 2 to about 15 weight percent butene-1 with propylene representing the balance. The foregoing EPB terpolymers may be characterized by a melt index at 230° C. of from about 2 to about 16 g/10 min, and advantageously from about 3 to about 7 g/10 min, a crystalline melting point of from about 100° C. to about 140° C., an average molecular weight of from about 25,000 to about 100,000 and a density within the range of from about 0.89 to about 0.92 g/cm³. An example of a commercially available terpolymer that may be used as the skin layer is XPM 7700, available from CHISSO.

If a blend of Ziegler-Natta catalyzed EPB terpolymer and EP random copolymer is used as the skin layer, the blend may contain from about 10 to about 90 weight percent EPB terpolymer and preferably from about 40 to about 60 weight percent EPB terpolymer, the balance being made up of EP random copolymer.

The intermediate layer(s) that is optionally provided between the base layer and the heat-seal layer and/or the base layer and the skin layer also comprises a polymeric matrix comprising any of the film-forming polymers. Suitable film-forming polymers for forming the polymeric matrix of the intermediate layer(s) include, but are not limited to, any of the film-forming polymers disclosed above with reference to the skin layer.

In order to modify or enhance certain properties of the multilayer films of the present invention for specific end-uses, it is possible for one or more of the layers to contain appropriate additives in effective amounts. As will be readily understood by one of ordinary skill in the art, an “effective amount” is an amount sufficient to achieve the desired effect, e.g., an antiblocking effect for antiblock additives or an antistatic effect for antistatic additives. Preferred additives include, but are not limited to anti-blocks, anti-static agents, coefficient of friction (COF) modifiers, processing aids, colorants, clarifiers, and other additives known to the artisan.

Also, one or both outer surfaces of the present film structures, e.g., one or both of the outer surface of the heat-seal layer and the outer surface of the skin layer, may be surface-treated. The surface treatment can be carried out by any method known in the art, including, but not limited to, corona discharge treatment, flame treatment, or plasma treatment. Although any of these techniques may effectively surface-treat, a particularly desirable method of treatment is the so-called corona treatment method, which comprises exposing the film surface to a high voltage corona discharge while passing the film between a pair of spaced electrodes. The outer surface(s) of the present film structures may be treated to a surface tension level of at least about 35 dynes/cm, e.g. from about 38 to 55 dynes/cm, in accordance with ASTM Standard D2578-84.

One or both outer surfaces of the present film structures, e.g., one or both of the outer surface of the heat-seal layer and the outer surface of the skin layer, may optionally have a coating applied thereon. An appropriate coating includes, but is not limited to, an acrylic coating, such as those described in U.S. Pat. Nos. 3,753,769 and 4,865,908, both of which are incorporated herein by reference, an ethylene acrylic acid copolymer (EAA) coating, an ethylene methacrylic acid copolymer (EMA) coating, an acrylonitrile coating, a polyvinylidene chloride (PVdC) coating, such as those described in U.S. Pat. Nos. 4,214,039, 4,447,494, 4,961,992, 5,019,447, and 5,057,177, all of which are incorporated herein by reference, a polyvinyl alcohol (PVOH) coating, a urethane coating, an epoxy coating, and blends thereof.

Examples of commercially available PVOH materials include VINOL 125, 99.3+% super hydrolyzed polyvinyl alcohol and VINOL 325, 98% hydrolyzed polyvinyl alcohol, each of which may be obtained from Air Products, Inc. For additional examples of PVOH coatings, see, for example, U.S. Pat. Nos. 4,927,689, 5,230,963, and 5,547,764, which are incorporated herein by reference.

The coating may be applied in an amount such that there will be deposited upon drying a smooth, evenly distributed layer, generally on the order of from about 0.01 to about 0.2 mil thickness (equivalent to about 0.2 to 3.5 g per 1000 sq. in. of film). Generally, the coating comprises 1 to 25 wt %, preferably 7 to 15 wt % of the entire coated film composition. The coating on the outer film surface(s) is subsequently dried by hot air, radiant heat or by any other convenient means.

Prior to the application of the coating, the chosen outer surface may be primed with a primer material. An appropriate primer material includes, but is not limited to, a poly(ethyleneimine) primer and an epoxy primer.

Alternatively, the outer surface of the present film structures opposite the metallocene-catalyzed propylene copolymer-containing heat-seal layer may have applied thereto a substrate, such as another polymer film or laminate, a cellulosic web(s), e.g., numerous varieties of paper, such as corrugated paperboard, craft paper, glassine, and cartonboard, nonwoven tissue, e.g., spunbonded polyolefin fiber, melt-blown microfibers, etc. The application may employ a suitable adhesive, e.g., a hot melt adhesive, such as low density polyethylene, ethylene-methacrylate copolymer, a water-based adhesive, such as polyvinylidene chloride latex, and the like.

In a particular embodiment, a film structure according to the present invention comprises a skin layer on a side of the base layer opposite the heat-seal layer, and the skin layer is metallized. Application of a metal coating layer to such a skin layer may be accomplished by vacuum deposition, or any other metallization technique, such as electroplating or sputtering. The metal of the metal coating layer may be aluminum, or any other metal capable of being vacuum deposited, electroplated, or sputtered, such as, for example, gold, zinc, copper, or silver. The thickness of the deposited metal coating may be from about 5 to about 200 nanometers (nm), for example, from about 10 to 100 nm, e.g. from about 30 to about 80 nm.

Although the thickness of the film, and the thicknesses of the individual layers of the film, is not critical, in certain embodiments, the film has a total thickness ranging from about 0.2 mil to about 5 mils, preferably from about 0.4 mil to about 2.5 mils. The thickness of the base layer preferably ranges from about 50% to about 99%, the thickness of each intermediate layer, if any, preferably ranges from 0% to 25%, and the thickness of the heat-seal layer, and skin layer on a side of the base layer opposite the heat-seal layer if one is present, preferably ranges from 1% to 15%, wherein, for each case, the example range is based on the entire thickness of the film structure.

It is preferred that the layers of the multilayer film structure of the present invention be coextruded. Specifically, the film-forming polymers of each layer are brought to the molten state and coextruded from an extruder through a flat sheet die, the melt streams being combined in an adapter prior to being extruded from the die or within the die. After leaving the die, the multilayer film structure is chilled, and the quenched structure is reheated. The multilayer film structure of the present invention may be prepared by employing commercially available systems for coextrusion.

After reheating, the quenched structure is molecularly oriented in the longitudinal, i.e. machine, direction and, optionally, in the transverse direction. This uniaxial or biaxial orientation, which greatly improves the stiffness and tensile strength properties of the film, is accomplished by using conventional techniques to sequentially stretch the film from, for example, about 2 to 8 times in the machine direction and optionally, from about 5 to 12 times in the transverse direction, at a drawing temperature of from about 100° C. to about 200° C. Preferably, the film is oriented by biaxially stretching the film. For further information concerning biaxial orientation, see, for example, U.S. Pat. No. 5,885,721, which is incorporated herein in its entirety.

For embodiments wherein a skin layer on a side of the base layer opposite the heat-seal layer has a coating applied thereon, the coextruded film structure can be stretched in the machine direction, coated with the coating composition (extrusion coated), and then stretched perpendicularly in the transverse direction. In yet another embodiment, the coating can be carried out after biaxial orientation is completed.

For some applications, it may be desirable to produce the polymer substrate by a cast film or chill roll extrusion process, rather than a coextrusion and orientation process. In this case, the final film structure is essentially nonoriented, and generally much less stiff than in cases where the film structure is prepared by a coextrusion and orientation process.

### EXAMPLE

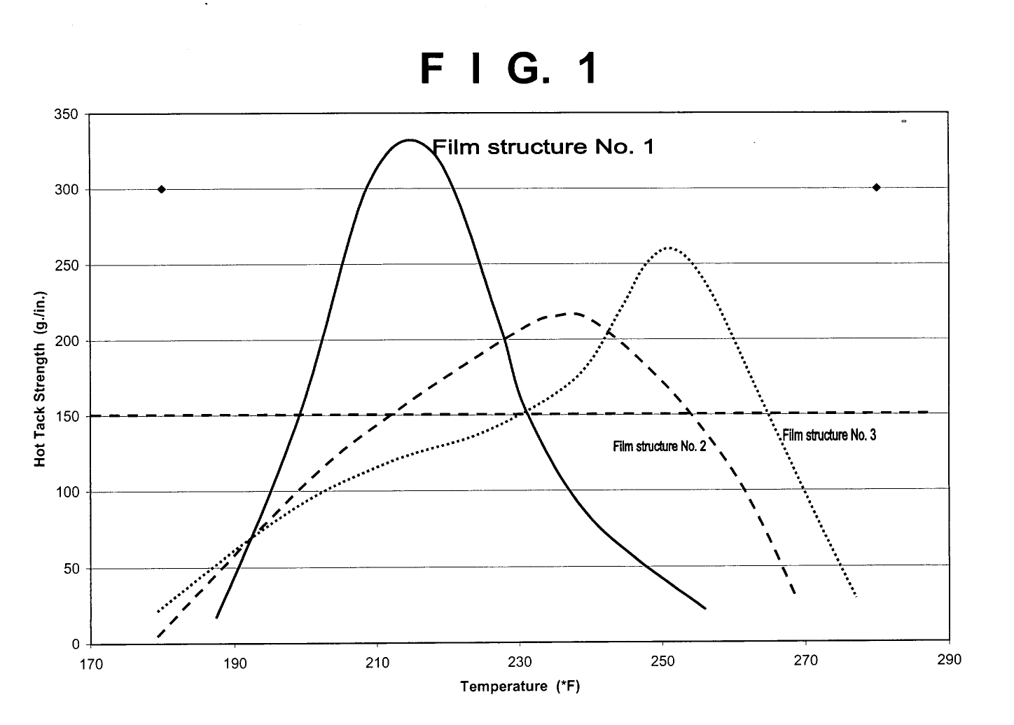

Three separate film structures were prepared and their hot tack performance was evaluated. FIG. 1 illustrates the results of the evaluation.

Each of the three film structures was a 3-layer film comprising a base layer of propylene homopolymer (melt flow=3 g/10 min). For each of the three structures, a Ziegler-Natta-catalyzed ethylene-propylene-butene-1 (EPB) terpolymer was on one side of the base layer. On the opposite of the base layer, each of the three film structures had one of the following specific heat-seal layers.

In structure No. 1, the heat-seal layer was a metallocene-catalyzed propylene copolymer according to the present invention. In structure No. 2, which is a comparative film structure, the heat-seal layer was a Ziegler-Natta-catalyzed EPB terpolymer (terpolymer A) different from the EPB terpolymer on the opposite side of the film structure. In structure No. 3, which is also a comparative film structure, the heat-seal layer was a Ziegler-Natta-catalyzed EPB terpolymer (terpolymer B) different from both the EPB terpolymer on the opposite side of the film structure and terpolymer A from film structure No. 2.

The hot tack performance of each of the three separate film structures was evaluated by placing a specimen thereof over a flat spring and bending the specimen and spring into a “U” shape with the sealing surfaces placed together. The sealing surfaces were placed into the jaws of a crimp sealer to make a seal. While the sealing jaws were closed, the spring tension was released. The amount of tension (g/in) needed to pull the seals more than ⅛″ apart was the hot tack value.

Given that a heat-seal layer according to the present invention has a MST of below 225° F. (107° C.), e.g., from about 180° F. to about 210° F. (82° C. to 99° C.), the heat-seal layer of film structure No. 1 advantageously exhibits its peak hot tack strength (˜315 g/in) at a temperature close to its minimum sealing temperature (MST). This feature of film structure No. 1 maximizes the line operating speed that can be achieved in a packaging process. In addition, film structure No. 1 exhibits adequate hot tack values (over 150 g/in) over a broad temperature range, for greater packaging process flexibility.

By contrast, comparative film structures Nos. 2 and 3, the heat-seal layers of which also have a MST below about 225° F. (107° C.), exhibit their peak hot tack strength at a temperature that is further removed from their MST. In addition, the peak hot tack strength exhibited by comparative film structures Nos. 2 and 3 is significantly lower than the peak hot tack strength of film structure No. 1.

What is claimed is:

1. A multilayer film structure comprising:
(a) a base layer comprising a film-forming thermoplastic polymer; and
(b) a heat-seal layer comprising a metallocene-catalyzed propylene copolymer, wherein the copolymer comprises from 80 to 99.5 wt % of propylene and from 0.5 to 20 wt % of an α-olefin, based on the entire weight of the copolymer.

2. The multilayer film structure of claim 1, wherein the copolymer comprises from 89 to 98 wt % of propylene and from 2 to 11 wt % of an α-olefin, based on the entire weight of the copolymer.

3. The multilayer film structure of claim 1, wherein the α-olefin is ethylene.

4. The multilayer film structure of claim 1, wherein the film structure is a coextruded and biaxially-oriented film structure.

5. The multilayer film structure of claim 1, wherein the base layer further comprises a cavitating agent.

6. The multilayer film structure of claim 1, wherein the base layer further comprises a hydrocarbon resin.

7. The multilayer film structure of claim 1, further comprising, on a side of the base layer opposite the heat-seal layer, a skin layer comprising a film-forming polymer.

8. The multilayer film structure of claim 7, further comprising one or more intermediate layers comprising a film-forming polymer between the base layer and heat-seal layer.

9. The multilayer film structure of claim 8, further comprising one or more intermediate layers comprising a film-forming polymer between the base layer and the skin layer.

10. The multilayer film structure of claim 7, wherein one or both of the heat-seal layer and the skin layer are surface-treated to a surface tension level of from about 38 to 55 dynes/cm by a treatment selected from the group consisting of corona discharge treatment, flame treatment, and plasma treatment.

11. The multilayer film structure of claim 7, wherein one or both of the heat-seal layer and the skin layer have a coating applied thereon, and the coating is selected from the group consisting of an ethylene acrylic acid copolymer coating, an ethylene methacrylic acid copolymer coating, an acrylonitrile coating, a polyvinylidene chloride coating, a polyvinyl alcohol coating, a urethane coating, an epoxy coating, and blends thereof.

12. The multilayer film structure of claim 11, wherein the heat-seal layer has a coating applied thereon, and the multilayer film structure further comprises a heat seal formed by contacting a surface of the coated heat seal layer with another film surface under sufficient conditions of heat and pressure to form a seal.

13. The multilayer film structure of claim 7, wherein the skin layer has a metal coating layer applied thereon.

14. The multilayer film structure of claim 1, further comprising at least one heat seal formed by contacting a surface of the heat seal layer with another film surface under sufficient conditions of heat and pressure to form a seal.

15. A method of manufacturing the multilayer film structure of claim 1, comprising the steps of:
(a) coextruding the base layer with the first skin layer; and
(b) orienting the coextruded film structure in at least one direction.

16. A multilayer film structure comprising:
(a) a base layer comprising a film-forming thermoplastic polymer; and
(b) a first skin layer essentially comprising a metallocene-catalyzed propylene copolymer, wherein the copolymer comprises from 80 to 99.5 wt % of propylene and from 0.5 to 20 wt % of an α-olefin, based on the entire weight of the copolymer.

17. The multilayer film structure of claim 16, further comprising at least one heat seal formed by contacting a surface of the heat seal layer with another film surface under sufficient conditions of heat and pressure to form a seal.
